(19) United States
(12) Patent Application Publication
(10) Pub. No.: US 2009/0092812 A1
(43) Pub. Date: Apr. 9, 2009

(54) Transparent PVC sheet for cutting-off infrared and ultra-violet

(75) Inventors: Sung-Yeh Shieh, Taipei (TW); Dein-Run Fung, Taipei (TW); Ying-Te Huang, Taipei (TW); Chao-Hsien Lin, Taipei (TW); Chia-Ho Cheng, Taipei (TW); Wen-Yi Wu, Taipei (TW)

Correspondence Address: BACON & THOMAS, PLLC, 625 SLATERS LANE, FOURTH FLOOR, ALEXANDRIA, VA, 22314-1176, US

(73) Assignee: NAN YA PLASTICS CORPORATION, Taipei (TW)

(21) Appl. No.: 11/907,022

(22) Filed: Oct. 9, 2007

(51) Int. Cl. B32B 27/30

(52) U.S. Cl. 428/220

(57) ABSTRACT

A heat-insulating transparent PVC sheet is made by a non-coating process for cutting-off infrared and ultra-violet, which production method of the heat-insulating transparent PVC sheet uses the conventional process for making PVC sheets, and a mixture of specific formula of PVC resin, plasticizer, inorganic heat-insulating particles or other additive is used directly to make the heat-insulating transparent PVC sheet to keep the properties of PVC and to provide transparency, low haze and an excellent effect for cutting-off infrared and ultra-violet.

### BACKGROUND OF THE INVENTION

1. Field of the Invention

The present invention relates to a heat-insulating transparent PVC sheet, and more particularly, to a heat-insulating transparent PVC sheet made by a non-coating process for cutting-off infrared and ultra-violet.

2. Description of the Related Art

As shown in FIG. 1, a conventional heat-insulating transparent PVC sheet 10 allows visible light to pass and cuts off infrared, and is generally pasted on the glass of buildings or cars for providing a heat-insulating effect and transparency to meet visual requirement.

However, the conventional heat-insulating transparent PVC sheet 10 does not cut off the ultra-violet well. Therefore, an UV absorbent is generally added in the PVC sheet then pasted on the glass of buildings or cars for providing an effect of cutting-off ultra-violet and thereby human bodies are protected from the damage of ultra-violet.

The processes of making conventional heat-insulating transparent PVC sheets include a dry-coating process and a wet-coating process. In both processes, a heat-insulating layer is coated on a plastic substrate and then a heat-insulating transparent sheet is produced.

As shown in FIG. 1, a heat-insulating transparent sheet 10 made by the dry-coating process has a metal, metallic oxide or inorganic material 12 uniformly attached on a plastic substrate 11 by a vacuum sputtering or evaporating process as a heat-insulating layer.

As shown in FIG. 2, in a heat-insulating transparent sheet 20 made by the wet-coating process, heat-insulating inorganic particles 22 are distributed uniformly in an appropriate resin 23 and solvent to form a coating liquid with appropriate viscosity for coating on a plastic substrate 21. After drying to remove the solvent, the inorganic particles 22 and the resin 23 become a heat-insulating layer attached on the plastic substrate 21.

However, two processes are needed in the above either the dry-coating process or the wet-coating process requires two procedures. One is making the plastic substrate and the other is coating the plastic substrate with a heat-insulating layer. Therefore, the drawbacks of the dry-coating and wet-coating processes of conventional heat-insulating sheets comprise complicated procedures, expensive equipments and slow production speed. Besides, environmental issues of waste solvents exist in the wet-coating processes.

### SUMMARY OF THE INVENTION

The main objective of the present invention is to provide a heat-insulating transparent PVC sheet and the production method thereof. A mixture of specific formula works as a raw material, and a conventional process for making PVC sheets is used directly without a coating process to produce the heat-insulating transparent PVC sheet for cutting-off infrared and ultra-violet.

The production method of the present invention is that, in a conventional process for making PVC sheets, a mixture of specific formula of PVC resin, plasticizer, inorganic heat-insulating particles or other additive undergoes a calendering process by a Calender, or undergoes a T-Die process by a T-Die machine, or undergoes a blow-molding process by a blow-molding machine, to become a heat-insulating transparent PVC sheet. This heat-insulating transparent PVC sheet keeps the properties of PVC and has transparency, low haze and an excellent effect for cutting-off infrared and ultra-violet.

The production method of a heat-insulating transparent PVC sheet according to the present invention uses the conventional process for making PVC sheets directly, and therefore not only coating processes is avoided but also the equipment investment for coating processes is saved. Moreover, the environmental issues of waste solvents in the wet-coating process are prevented. Therefore, the production method has advantages of simple procedures, low production costs, fast production speed and environmental friendliness.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a cross-sectional enlarged view of a heat-insulating transparent sheet produced by a conventional dry-coating process;

FIG. 2 is a cross-sectional enlarged view of a heat-insulating transparent sheet produced by a conventional wet-coating process;

FIG. 3 is a cross-sectional enlarged view of a heat-insulating transparent PVC sheet made by a non-coating process for cutting-off infrared and ultra-violet according to one preferred embodiment of the present invention;

FIG. 4 is a schematic view showing that the heat-insulating transparent PVC sheets are stacked for use; and

FIG. 5 is a schematic view showing that the heat-insulating transparent PVC sheet is stacked with another plastic substrate for use.

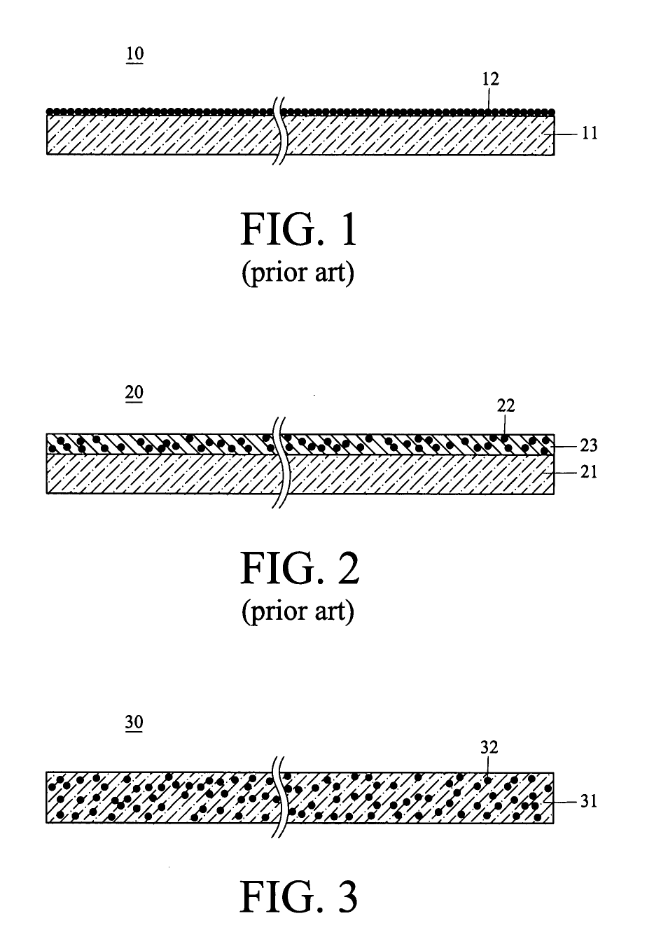

### DETAILED DESCRIPTION OF THE PREFERRED EMBODIMENT

As shown in FIG. 3, a heat-insulating transparent PVC sheet 30 according to one preferred embodiment of the present invention is a soft, semi-hard or hard sheet of thickness of 0.02˜1.0 mm and has transparency as well as a characteristic of cutting-off infrared and ultra-violet. The disclosed heat-insulating transparent PVC sheet 30 is characterized by: a PVC sheet 31 of thickness of 0.02˜1.0 mm as a substrate and inorganic heat-insulating particles 32 uniformly distributed in the PVC sheet 31.

The production method of the heat-insulating transparent PVC sheet 30 according to one preferred embodiment of the present invention uses a mixture of specific formula as a raw material, and a conventional process for making PVC sheets is used directly without a coating process to produce the heat-insulating transparent PVC sheet 30 for cutting-off infrared and ultra-violet, and has advantages of simple procedures, low equipment costs and fast production speed.

The production method of the heat-insulating transparent PVC sheet 30 includes the following steps:

(1) Mixing raw materials including PVC resin of 100 PHR, plasticizer of 0˜85 PHR, inorganic heat-insulating particles of 0.3˜15 PHR, stabilizer of 0.1˜15 PHR, lubricant of 0.1˜15 PHR, additive (including modifier, surfactant, dispersant and UV absorbent) of 0.3˜25 PHR and colorant of 0.0˜12 PHR by a mixing machine, and then drawing the mixture into a Banbury mixer for refinement;

(2) Controlling the mixture temperature at 160˜180° C., heating and shearing the mixture in a roller machine for well-gelation, and proceeding one of the following processes:
(i) calendering the mixture by a Calender to form a heat-melting sheet of thickness of 0.05˜1.0 mm, drawing water at 20˜85° C. therein for cooling to improve the transparency of the PVC sheet after forming, and then entering step (3) after dehydration;
(ii) processing the mixture by a T-Die machine to form a heat-melting sheet of thickness of 0.05˜1.0 mm, and then entering step (3) after forming; or
(iii) processing the mixture by a blow-molding machine to form a heat-melting sheet of thickness of 0.02˜0.08 mm, and then entering step (3) after forming; and

(3) Drawing the sheet into a cooling wheel for cooling and shaping, and then rolling up the sheet to realize the heat-insulating transparent PVC sheet 30.

In the step (1), the PVC resin can be one or a composition of more than one of a PVC polymer or copolymer made by bulk polymerization, solution polymerization, suspension polymerization or emulsion polymerization.

In the step (1), the plasticizer can be one or more than one selected from the group consisting of a phosphate, phthalic acid group, trimellitate, epoxy, polyester, chlorinated hydrocarbon and aliphatic acid ester.

In the step (1), the inorganic heat-insulating particles 32 is of particle size of 0.005˜2 μm, and can be one or more than one selected from the group consisting of TiO₂, ZnO, V₂O₅, In₂O₃, CeO₂, SnO₂, Sb₂O₃, ZnS, ATO (tin oxide antimony doped), ITO (tin oxide indium doped) and metallic oxide according to desired properties such as transparency, haze and so on.

In the step (1), the stabilizer can be one or more than one selected from the group consisting of a Ba—Zn group, Ca—Zn group and organic Sn.

In the step (1), the lubricant can be one, more than one or all selected from the group consisting of a stearic acid, fatty acid, fatty acid amide, ester group, metallic crystal carbonate and organic silicon group.

In the step (1), the additive can be one or more than one selected from the group consisting of a coupling agent, surfactant, dispersant, high polymer modifier and UV absorbent. The purpose of adding dispersant is to distribute the inorganic heat-insulating particles 32 uniformly in the PVC sheet 31.

The coupling agent can be selected from the group consisting of organosilane compound, organic Zr—Al compound and organic Ti—Al compound. The dispersant can be one or more than one selected from the group consisting of a high copolymer dispersant, dispersant containing silicon and dispersant containing fluorine. The UV absorbent can be one or more than one selected from the group consisting of 1-hydroxybenzotrizole and hydroxy benzophenone.

In the step (1), the colorant can be added more or less according to the desired hue of the product, and can be organic colorant, inorganic colorant or a mixture of both.

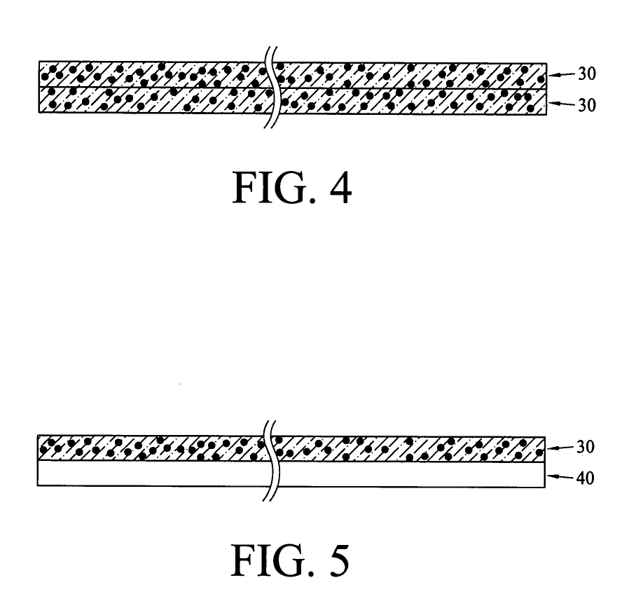

While in use, the heat-insulating transparent PVC sheet 30 can not only be a single layer but also be stacked as shown in FIG. 4, or be stacked with another plastic substrate 40 as shown in FIG. 5.

### Example of Embodiment

Preferred embodiments are shown below to describe the properties of the heat-insulating transparent PVC sheet 30 produced according to the production method of the present invention. In addition, the determination of each property of the heat-insulating transparent PVC sheet 30 is following the test methods as described below.

### (1) Test of Visible Light Transmittance and Haze:

A light transmittance and haze meter of model number TC-H□ produced by Tokyo Denshoku Co., Ltd is used according to the JIS K7705 test standard to test the light transmittance and haze of the PVC sheet. When the test result shows high visible light transmittance and low haze, the PVC sheet has a good transparency.

### (2) Test of Cutting-Off Rate of Infrared and Ultra-Violet:

An infrared cutting-off rate tester of model number LT-3000 produced by HOYA is used according to the JIS R3106 test standard to test the cutting-off rate of infrared of the PVC sheet. When the test result shows high infrared cutting-off rate, the PVC sheet has a good heat-insulating effect; and when the test result shows low UV transmittance, the PVC sheet has a good UV cutting-off effect.

### Example 1

The production method of a heat-insulating transparent PVC sheet 30 of thickness of 0.2 mm and softness of 40 PHR is as follows:

(1) Mixing raw materials as PVC resin, plasticizer, inorganic heat-insulating particles, additive (including modifier, surfactant, dispersant and UV absorbent), stabilizer and lubricant according to the specific formula in Table 1 by a mixing machine, and then drawing the mixture into a Banbury mixer for refinement;

(2) Controlling the mixture temperature at 160˜180° C., heating and shearing the mixture in a roller machine, and then calendering the mixture by a Calender to form a heat-melting sheet of thickness of 0.2 mm, drawing water at 20˜85° C. therein so as to cool and harden the sheet; and

(3) After dehydration, drawing the sheet into a cooling wheel for cooling and shaping, and then rolling up the sheet into the heat-insulating transparent PVC sheet 30 of thickness of 0.2 mm and softness of 40 PHR.

The test result is shown in Table 1. The heat-insulating transparent PVC sheet 30 has a good transparency, infrared and UV cutting-off rate. Besides, ATO is not plated out during the process.

### Example 2

Except that the thickness is made as 0.3 mm, the formula of raw materials and production method of the heat-insulating transparent PVC sheet 30 is the same as that in the example 1.

The test result is shown in Table 1. The heat-insulating transparent PVC sheet 30 of thickness of 0.3 mm has a good transparency, infrared and UV cutting-off rate. Besides, ATO is not plated out during the process.

### Example 3

Except the adoption of the blow-molding process, the specific formula as in Table 1 of raw materials and production method of the heat-insulating transparent PVC sheet 30 of thickness of 0.02 mm and softness of 40 PHR is the same as that in the example 1.

The test result is shown in Table 1. The heat-insulating transparent PVC sheet 30 has a good transparency, infrared and UV cutting-off rate. Besides, ATO is not plated out during the process.

### Example 4

Except that the thickness is made as 1.0 mm, the formula of raw materials and production method of the heat-insulating transparent PVC sheet 30 is the same as that in the example 1.

The test result is shown in Table 1. The heat-insulating transparent PVC sheet 30 of thickness of 1.0 mm has a good transparency, infrared and UV cutting-off rate. Besides, ATO is not plated out during the process.

### Example 5

Except the adoption of the T-Die process, the specific formula as in Table 1 of raw materials and production method of the heat-insulating transparent PVC sheet 30 of thickness of 0.2 mm and softness of 40 PHR is the same as that in the example 1.

The test result is shown in Table 1. The heat-insulating transparent PVC sheet 30 has a good transparency, infrared and UV cutting-off rate. Besides, ATO is not plated out during the process.

### Example 6

Except that the thickness is made as 0.3 mm, the formula of raw materials and production method of the heat-insulating transparent PVC sheet 30 is the same as that in the example 5.

The test result is shown in Table 1. The heat-insulating transparent PVC sheet 30 of thickness of 0.3 mm has a good transparency, infrared and UV cutting-off rate. Besides, ATO is not plated out during the process.

### Example 7

According to the specific formula as in Table 1, a heat-insulating transparent PVC sheet 30 of thickness of 0.2 mm and softness of 40 PHR is produced according to the production method in the example 1.

The test result is shown in Table 1. The heat-insulating transparent PVC sheet 30 has a good transparency, infrared and UV cutting-off rate. Besides, ATO is not plated out during the process.

### Example 8

Except that the thickness is made as 0.3 mm, the formula of raw materials and production method of the heat-insulating transparent PVC sheet 30 is the same as that in the example 7.

The test result is shown in Table 1. The heat-insulating transparent PVC sheet 30 of thickness of 0.3 mm has a good transparency, infrared and UV cutting-off rate. Besides, ATO is not plated out during the process.

### Comparative Example 1

Except that the raw materials of the heat-insulating transparent PVC sheet 30 do not include the inorganic heat-insulating particles, modifier, surfactant and dispersant, the production method is the same as that in the example 1.

The test result is shown in Table 1. The raw materials of the heat-insulating transparent PVC sheet of thickness of 0.2 mm do not contain the inorganic heat-insulating particles and thus the infrared cutting-off rate is worse than those in the examples 1, 5 and 7.

### Comparative Example 2

Except that the raw materials of the heat-insulating transparent PVC sheet 30 do not include the modifier, surfactant and dispersant, the production method is the same as that in the example 1.

The test result is shown in Table 1. The raw materials of the heat-insulating transparent PVC sheet of thickness of 0.2 mm do not contain the modifier, surfactant and dispersant and thus the infrared and UV cutting-off rates are worse than those in the examples 1, 5 and 7. In addition, ATO is plated out during the process and affects the production process and quality of the transparent PVC sheet.

### Comparative Example 3

A colorless transparent glass of size of 100 mm*100 mm*0.3 mm is used as comparison to measure the light transmittance, haze, infrared and UV cutting-off rates.

The test result is shown in Table 1. The infrared and UV cutting-off rates of the colorless transparent glass is worse than those in the example s 2, 4, 6 and 8.

TABLE 1

| | | NAME | Example 1 | Example 2 | Example 3 | Example 4 | Example 5 | Example 6 |
|---|---|---|---|---|---|---|---|---|
| Formula | Substrate | PVC | 100 | 100 | 100 | 100 | 100 | 100 |
| | | Colorless | — | — | — | — | — | — |
| | | transparent | | | | | | |
| | | glass | | | | | | |
| | Plasticizer | DINP | 40 | 40 | 40 | 40 | 40 | 40 |
| | Inorganic | ATO | 2.2 | 2.2 | 0.3 | 2.2 | 6.0 | 6.0 |
| | Heat-insulating | | | | | | | |
| | particles | | | | | | | |
| | Stabilizer | Ba—Zn | 3 | 3 | 3 | 3 | 3 | 3 |
| | | group | | | | | | |
| | Lubricant | Stearic | 0.4 | 0.4 | 0.4 | 0.4 | 0.4 | 0.4 |
| | | acid | | | | | | |
| | Additive | Modifier | 3.2 | 3.2 | 0.44 | 3.2 | 5.73 | 5.73 |
| | | Surfactant | 0.82 | 0.82 | 0.11 | 0.82 | 1.24 | 1.24 |
| | | Dispersant | 0.75 | 0.75 | 0.10 | 0.75 | 0.95 | 0.95 |
| | | UV | | | | | | |
| | | absorbent | 0.8 | 0.8 | 0.8 | 0.8 | 0.8 | 0.8 |

| | | | | | | | |
|---|---|---|---|---|---|---|---|
| Properties | Substrate thickness | 0.2 | 0.3 | 0.02 | 1.0 | 0.2 | 0.3 |
| | (mm) | | | | | | |
| | Light transmittance (%) | 69 | 58 | 85 | 49 | 40 | 26 |
| | Haze (%) | 2.2 | 2.5 | 1.2 | 3.1 | 8.7 | 10.3 |
| | Infrared cutting-off rate | 43 | 61 | 14 | 70 | 73 | 87 |
| | (%) | | | | | | |
| | UV cutting-off rate (%) | 99 | 99 | 98 | 99 | 99 | 99 |

| | | | | | | |
|---|---|---|---|---|---|---|
| ATO is plated out or not | no | no | no | no | no | no |

| | | | | | Compa. | Compa. | Compa. |
|---|---|---|---|---|---|---|---|
| | | NAME | Example 7 | Example 8 | example 1 | example 2 | example 3 |
| Formula | Substrate | PVC | 100 | 100 | 100 | 100 | — |
| | | Colorless | — | — | — | — | ν |
| | | transparent | | | | | |
| | | glass | | | | | |
| | Plasticizer | DINP | 40 | 40 | 40 | 40 | — |
| | Inorganic | ATO | 15 | 15 | — | 2.2 | — |
| | Heat-insulating | | | | | | |
| | particles | | | | | | |
| | Stabilizer | Ba—Zn | 3 | 3 | 3 | 3 | — |
| | | group | | | | | |
| | Lubricant | Stearic | 0.4 | 0.4 | 0.4 | 0.4 | — |
| | | acid | | | | | |
| | Additive | Modifier | 7.18 | 7.18 | — | — | — |
| | | Surfactant | 3.59 | 3.59 | — | — | — |
| | | Dispersant | 2.61 | 2.61 | — | — | — |
| | | UV | | | | | |
| | | absorbent | 0.8 | 0.8 | 0.8 | 0.8 | — |

| | | | | | | |
|---|---|---|---|---|---|---|
| Properties | Substrate thickness | 0.2 | 0.3 | 0.2 | 0.2 | 0.3 |
| | (mm) | | | | | |
| | Light transmittance (%) | 19 | 17 | 86 | 50 | 93 |
| | Haze (%) | 10.4 | 12.7 | 1.4 | 12.0 | 0.6 |
| | Infrared cutting-off rate | 92 | 95 | 8 | 29 | 22 |
| | (%) | | | | | |
| | UV cutting-off rate (%) | 99 | 99 | 98 | 98 | 27 |

| | | | | | |
|---|---|---|---|---|---|
| ATO is plated out or not | no | no | no | yes | — |

Ingredient unit: PHR (per hundred unit weight of resin)

What is claimed is:

1. A heat-insulating transparent PVC sheet, comprising a PVC sheet of thickness of 0.02˜1.0 mm as a substrate thereof and inorganic heat-insulating particles distributed in the PVC sheet, which is characterized by being made through following production steps:
(1) mixing PVC resin of 100 PHR, plasticizer of 0˜85 PHR, inorganic heat-insulating particles of 0.3˜15 PHR, stabilizer of 0.1˜15 PHR, lubricant of 0.1˜15 PHR, additive (including modifier, surfactant, dispersant and UV absorbent) of 0.3˜25 PHR and colorant of 0.0˜12 PHR into a mixture by a mixing machine, and then drawing the mixture into a Banbury mixer for refinement;
(2) controlling the mixture temperature at 160˜180° C., heating and shearing the mixture in a roller machine for well-gelation, and proceeding one of the following processes:
(i) calendering the mixture by a Calender to form a heat-melting sheet of thickness of 0.05˜1.0 mm, drawing water at 20˜85° C. therein for cooling to improve the transparency of the PVC sheet after forming, and then entering step (3) after dehydration;
(ii) processing the mixture by a T-Die machine to form a heat-melting sheet of thickness of 0.05˜1.0 mm, and then entering step (3) after forming; or
(iii) processing the mixture by a blow-molding machine to form a heat-melting sheet of thickness of 0.02˜0.08 mm, and then entering step (3) after forming;
(3) drawing the sheet into a cooling wheel for cooling and shaping, and then rolling up the sheet to realize the heat-insulating transparent PVC sheet.

2. The heat-insulating transparent PVC sheet as claimed in claim 1, wherein the additive comprises a modifier, surfactant, dispersant and UV absorbent.

3. The heat-insulating transparent PVC sheet as claimed in claim 2, wherein the dispersant is one or more than one selected from the group consisting of a high copolymer dispersant, dispersant containing silicon and dispersant containing fluorine, and the UV absorbent is one or more than one selected from the group consisting of 1-hydroxybenzotrizole and hydroxy benzophenone.

4. The heat-insulating transparent PVC sheet as claimed in claim 2, wherein the additive includes organosilane compound coupling agent, organic Zr—Al compound coupling agent and organic Ti—Al compound coupling agent.

5. The heat-insulating transparent PVC sheet as claimed in claim 2, wherein each of the inorganic heat-insulating particles has a particle size of 0.005˜2 μm and is one or more than one selected from the group consisting of TiO₂, ZnO, V₂O₅, In₂O₃, CeO₂, SnO₂, Sb₂O₃, ZnS, ATO and ITO.

6. The heat-insulating transparent PVC sheet as claimed in claim 3, wherein each of the inorganic heat-insulating particles has a particle size of 0.005˜2 μm and is one or more than one selected from the group consisting of TiO₂, ZnO, V₂O₅, In₂O₃, CeO₂, SnO₂, Sb₂O₃, ZnS, ATO and ITO.

7. The heat-insulating transparent PVC sheet as claimed in claim 4, wherein each of the inorganic heat-insulating particles has a particle size of 0.005˜2 μm and is one or more than one selected from the group consisting of TiO₂, ZnO, V₂O₅, In₂O₃, CeO₂, SnO₂, Sb₂O₃, ZnS, ATO and ITO.
